(19) United States
(12) Patent Application Publication
(10) Pub. No.: US 2026/0134243 A1
(43) Pub. Date: May 14, 2026

(54) IMAGE FORMING SYSTEM AND INFORMATION PROCESSING APPARATUS

(71) Applicant: CANON KABUSHIKI KAISHA, Tokyo (JP)

(72) Inventor: YUKIYOSHI HIKICHI, Tokyo (JP)

(21) Appl. No.: 19/378,857

(22) Filed: Nov. 4, 2025

(30) Foreign Application Priority Data
Nov. 8, 2024 (JP) 2024-196047

(51) Int. Cl. G06K 15/16; G06K 15/00; G06K 15/02

(52) U.S. Cl. CPC G06K 15/16; G06K 15/002; G06K 15/021

(57) ABSTRACT

An image forming system including an image forming apparatus that discharges a recording medium on which an image has been formed. The system selects, from among a plurality of stacking units that are operable to stack a recording medium discharged from the image forming apparatus, and in a case where a recording medium generated in the job is a long recording medium that has a larger length than a standard-sized recording medium in a conveyance direction, determines whether the selected stacking unit is a stacking unit suitable for stacking the long recording medium, and issues a warning if it has been determined that the selected stacking unit is not a stacking unit suitable for stacking the long recording medium.

### BACKGROUND

### Field of the Technology

The present disclosure relates to an image forming system and an information processing apparatus.

### Description of the Related Art

Conventionally, an image forming system has been proposed that outputs a print medium, especially a long sheet, that has been printed to an appropriate discharge tray. Such an image forming system includes an image forming apparatus and one or more discharge apparatuses. It also includes a long tray as an option. The long tray can be additionally installed on a discharge tray to reliably hold a discharged long sheet.

Japanese Patent Laid-Open No. 2019-95538 describes an image forming system that forms an image on a sheet that has a larger length than a standard-sized sheet in a conveyance direction (long paper). It is described therein that this image forming system selects one discharge tray which can discharge sheets based on sheet information and tray information, and which discharges sheets so that a conveyance distance of the sheets becomes shortest.

However, according to the technique described in the aforementioned Japanese Patent Laid-Open No. 2019-95538, no particular restrictions are placed on a user's selection of a discharge destination. Also, in the case of long paper, for the purpose of reducing a jam, the long paper is discharged to a tray with which a sheet conveyance distance becomes shortest. Therefore, even if an image forming apparatus includes a plurality of long trays, it is not possible to select a discharge tray other than a discharge tray that is automatically selected by the apparatus.

### SUMMARY

Embodiments of the present disclosure eliminate the above-mentioned issues with conventional technology.

A feature of embodiments of the present disclosure is to provide a technique that enables a presentation for discharging a long recording medium on which an image has been formed in an image forming apparatus to an appropriate stacking unit.

According to embodiments of the present disclosure, there is provided an image forming system including an image forming apparatus that discharges a recording medium on which an image has been formed, the image forming system comprising one or more controllers including one or more processors and one or more memories, the one or more controllers configured to: select, from among a plurality of stacking units that are operable to stack a recording medium discharged from the image forming apparatus thereon, a stacking unit on which a recording medium discharged from the image forming apparatus as a result of execution of a job is to be stacked; in a case where a recording medium generated in the job is a long recording medium that has a larger length than a standard-sized recording medium in a conveyance direction, determine whether the selected stacking unit is a stacking unit suitable for stacking the long recording medium; and issue a warning if it has been determined that the selected stacking unit is not a stacking unit suitable for stacking the long recording medium.

According to embodiments of the present disclosure, there is provided an information processing apparatus, comprising one or more controllers including one or more processors and one or more memories, the one or more controllers configured to: select a stacking unit on which a recording medium discharged from an image forming apparatus in which a job is to be executed is to be stacked, from among a plurality of stacking units that are operable to stack a recording medium discharged from the image forming apparatus after an image has been formed thereon; in a case where a recording medium generated in the job is a long recording medium that has a larger length than a standard-sized recording medium in a conveyance direction, determine whether the selected stacking unit is a stacking unit suitable for stacking the long recording medium; and issue a warning if it has been determined that the selected stacking unit is not a stacking unit suitable for stacking the long recording medium.

Further features of the various embodiments will become apparent from the following description of exemplary embodiments with reference to the attached drawings. The following descriptions of embodiments are described by way of example.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a diagram for describing a configuration of an image forming system according to a first embodiment of the present disclosure.

FIG. 2 is a block diagram for describing configurations of a printing apparatus, an inspection apparatus, an information processing apparatus, a client computer, and the like in the image forming system according to the first embodiment.

FIG. 3 is a schematic cross-sectional diagram for describing mechanisms of the printing apparatus, an inspection unit, a large-capacity stacker, a relay conveyance unit, and a finisher according to the first embodiment.

FIGS. 4A and 4B are diagrams for describing a long tray according to the first embodiment.

FIG. 5 depicts a view showing an example of an operation screen displayed on a display unit of the information processing apparatus according to the first embodiment.

FIG. 6 depicts a view showing an example of an operation screen displayed on the display unit of the information processing apparatus according to the first embodiment.

FIG. 7 depicts a view showing an example of an operation screen that is displayed when a custom button has been pressed.

FIG. 8 depicts a view showing an example of an operation screen for inputting job properties, which is displayed on the display unit of the information processing apparatus according to the first embodiment.

FIG. 9 depicts a view showing an example of a warning screen that is displayed when a non-recommended tray has been selected.

FIG. 10 is a diagram showing an example of a stacked state when long sheets have been discharged to each tray.

FIG. 11 is a flowchart for describing processing by the information processing apparatus for displaying a discharge destination list according to the first embodiment.

FIG. 12 is a flowchart for describing processing for displaying a warning screen upon selection of an non-recommended tray when a user selects a discharge destination tray on the information processing apparatus according to the first embodiment.

FIG. 13 is a functional block diagram for describing the functions of the inspection apparatus according to a second embodiment.

FIG. 14 depicts a view showing an example of a main screen displayed on a display unit of the inspection apparatus according to the second embodiment.

FIG. 15 depicts a view showing an example of an inspection setting screen displayed on the display unit of the inspection apparatus according to the second embodiment.

FIG. 16 depicts a view showing an example of an inspection screen that is displayed on the display unit when the inspection has been stopped, or before the inspection is started.

FIG. 17 depicts a view showing an example of an operation setting screen displayed on the display unit of the inspection apparatus according to the second embodiment.

FIG. 18 depicts a view showing an example of a warning screen that is displayed when an non-recommended tray has been selected on the operation setting screen according to the second embodiment.

FIG. 19 depicts a view showing an example of an environment setting screen displayed on the display unit of the information processing apparatus according to a third embodiment.

FIGS. 20A and 20B are flowcharts for describing processing by the information processing apparatus for displaying a discharge destination list according to the third embodiment.

FIG. 21 depicts a view showing an example of an operation screen displayed on the display unit of the information processing apparatus according to the third embodiment.

FIG. 22A is a diagram showing an example of discharge destination list information according to the first embodiment.

FIG. 22B is a diagram showing options of radio buttons, trays that are preferentially displayed, and the purposes thereof according to the third embodiment.

FIG. 22C is a diagram showing an example of discharge destination list information according to the third embodiment.

### DESCRIPTION OF THE EMBODIMENTS

Example embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted.

### First Embodiment

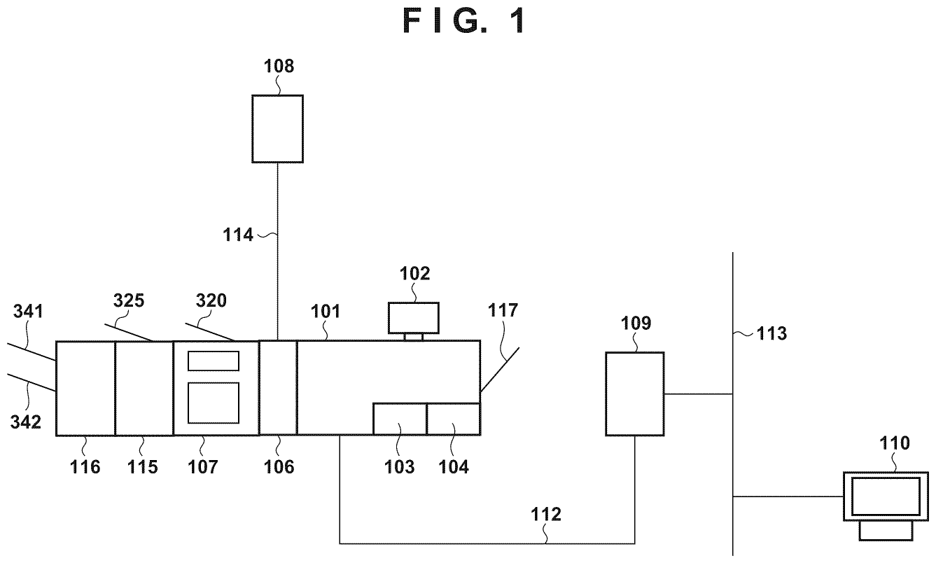

FIG. 1 is a diagram for describing a configuration of an image forming system according to a first embodiment of the present disclosure.

This image forming system roughly includes a printing apparatus (image forming apparatus) 101, an inspection apparatus 108, an information processing apparatus 109, and a client computer 110. Note that although the printing apparatus 101 according to the first embodiment will be described using a printing apparatus of an electrophotographic method as an example, it may be a printing apparatus of a different printing method, such as an inkjet method and an offset method.

The printing apparatus 101 is connected to the information processing apparatus 109 via a cable 112. The information processing apparatus 109 is connected to the client computer 110 via a network 113.

The printing apparatus 101 includes a user interface (UI) panel (operation panel) 102, a feed deck 103, a feed deck 104, and a manual feed tray 117. The UI panel 102 is a user interface that includes, for example, a capacitive touch panel.

Furthermore, the printing apparatus 101 includes an inspection unit 106, a large-capacity stacker 107, a relay conveyance unit 115, and a finisher 116 as optional accessories. The inspection unit 106 is connected to the inspection apparatus 108 via a cable 114. The large-capacity stacker 107 includes a main tray and a top tray 320, and several thousand sheets can be stacked on the main tray at a time. The relay conveyance unit 115 has sheet cooling and de-curler (removal of a curled state of printing sheets) functions, and also includes a top tray (stacking unit) 325 on which printed sheets can be stacked. The finisher 116 has functions for post processing, such as stapling, and includes a plurality of trays (stacking units) 341 and 342 for stacking sheets that have undergone finishing processing.

A print job is generated by the client computer 110, transmitted to the information processing apparatus 109 via the network 113, and managed by the information processing apparatus 109. Then, this print job is transmitted from the information processing apparatus 109 to the printing apparatus 101 via the cable 112, and the printing apparatus 101 executes processing for printing on a sheet (recording medium). The information processing apparatus 109 is, for example, a print controller. Note that it is permissible to adopt a mode in which a print job is generated and managed by the information processing apparatus 109, transmitted to the printing apparatus 101 via the network 113, and managed by the printing apparatus 101.

Furthermore, it is also permissible to adopt a mode in which the client computer 110, the information processing apparatus 109, and the inspection apparatus 108 are connected to the cable 112, and they can each communicate with the printing apparatus 101 via the cable 112. Moreover, it is also permissible to adopt a mode in which the inspection apparatus 108, too, is connected to the information processing apparatus 109 and the client computer 110 via the network 113. That is to say, the mode of connection among the printing apparatus 101, the information processing apparatus 109, and the client computer 110 shown in FIG. 1 is an example, and it goes without saying that there are a variety of modes of connection other than the one indicated by the present embodiment. In addition, it is also permissible to adopt a mode in which not only the above-described devices, but also a folding device, a book binding device, and the like, are connected to the printing apparatus 101.

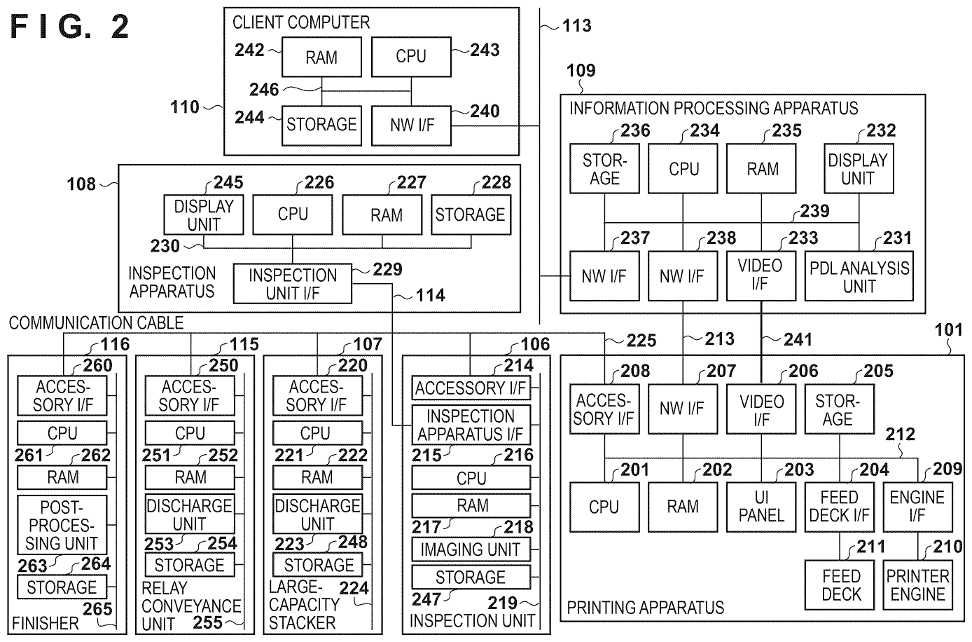

FIG. 2 is a block diagram for describing configurations of the printing apparatus 101, the inspection apparatus 108, the information processing apparatus 109, the client computer 110, and the like of the image forming system according to the first embodiment. First, a configuration of the printing apparatus 101 will be described.

A central processing unit (CPU) 201 takes charge of, for example, control on and computation of each unit inside the printing apparatus 101 via a system bus 212. The CPU 201 performs various types of control by executing a program that is stored in a storage 205 and has been deployed to a random access memory (RAM) 202. The RAM 202 is a type of a general volatile storage apparatus that can be directly accessed from the CPU 201, and is used as a working area for the CPU 201 and a temporary storage area for various types of data. Also, the storage 205 functions as a temporary storage area and a working memory while the printing apparatus 101 is in operation.

An engine I/F 209 takes charge of communication with and control on a printer engine 210. A feed deck I/F 204 takes charge of communication with and control on a feed deck 211. The feed decks 103 and 104 of FIG. 1 and an optional deck (not shown) are collectively referred to as the feed deck 211 as hardware configurations. A UI panel 203 is a hardware configuration of the UI panel 102 of FIG. 1, and provides a user interface of the printing apparatus 101.

A network interface (hereinafter, NW I/F) 207 is connected to a NW I/F 238 of the information processing apparatus 109 via a cable 213, and takes charge of communication between the information processing apparatus 109 and the printing apparatus 101. Note that, here, the connection form is such that the interfaces connected to the system buses 212 and 239 are connected directly to one another via the cable 213; however, the connection form may be such that the information processing apparatus 109 and the printing apparatus 101 are connected via, for example, a network and the like, and no limitation is intended regarding this connection form. A video I/F 206 is connected to a video I/F 233 of the information processing apparatus 109 via a video cable 241, and takes charge of communication of image data between the information processing apparatus 109 and the printing apparatus 101. The cable 112 in FIG. 1 may include the video cable 241 and the cable 241.

Note that the interfaces of the information processing apparatus 109 for connection to the printing apparatus 101 may be in a form where the functions of the NW I/F 238 and the video I/F 233 have been integrated. Also, the interfaces of the printing apparatus 101 for connection to the information processing apparatus 109 may be in a form where the functions of the NW I/F 207 and the video I/F 206 have been integrated.

An accessory I/F 208 connects to a plurality of accessory I/Fs 214, 220, 250, and 260 via a cable 225. That is to say, the printing apparatus 101 communicates with the inspection unit 106, the large-capacity stacker 107, the relay conveyance unit 115, and the finisher 116 via the accessory I/F 208.

Next, a configuration of the inspection unit 106 will be described.

A CPU 216 executes control on and computation of each unit inside the inspection unit 106 via a system bus 219 by deploying a program stored in a storage 247 to a RAM 217 and executing the program. The RAM 217 is a type of a general volatile storage apparatus that can be directly accessed from the CPU 216, and is used as a working area for the CPU 216 and a temporary storage area for various types of data. The storage 247 stores programs to be executed by the CPU 216 and further functions as a temporary storage area and a working memory while the inspection unit 106 is in operation. An inspection apparatus I/F 215 connects to an inspection unit I/F 229 of the inspection apparatus 108 via the cable 114. That is to say, the inspection unit 106 communicates with the inspection apparatus 108 via the inspection apparatus I/F 215 and the inspection unit I/F 229.

An imaging unit 218 has an imaging function equipped with, for example, a contact image sensor (hereinafter, CIS), captures an image of a sheet passing inside the inspection unit 106, and transmits the captured image to the inspection apparatus 108 via the inspection apparatus I/F 215. Note that the CIS of the imaging unit 218 is an example of a sensor, and may be another type of sensor, such as a CCD image sensor; no limitation is intended regarding an imaging method thereof. The accessory I/F 214 communicates with the printing apparatus 101, the large-capacity stacker 107, the relay conveyance unit 115, and the finisher 116 via the cable 225.

Next, a configuration of the large-capacity stacker 107 will be described.

A CPU 221 takes charge of, for example, control on and computation of each unit inside the large-capacity stacker 107 via a system bus 224 by deploying a program stored in a storage 248 to a RAM 222 and executing the program. The RAM 222 is a type of a general volatile storage apparatus that can be directly accessed from the CPU 221, and is used as a working area for the CPU 221 and a temporary storage area for various types of data. The storage 248 stores programs to be executed by the CPU 221 and further functions as a temporary storage area and a working memory while the large-capacity stacker 107 is in operation. A discharge unit 223 takes charge of an operation of discharge to the main tray and the top tray, and monitoring of and control on a stacked state of each of the main tray and the top tray 320. The accessory I/F 220 communicates with the printing apparatus 101, the inspection unit 106, the relay conveyance unit 115, and the finisher 116 via the cable 225.

Next, a configuration of the relay conveyance unit 115 will be described.

A CPU 251 takes charge of, for example, control on and computation of each unit inside the relay conveyance unit 115 via a system bus 255 by deploying a program stored in a storage 254 to a RAM 252 and executing the program. The RAM 252 is a type of a general volatile storage apparatus that can be directly accessed from the CPU 251, and is used as a working area for the CPU 251 and a temporary storage area for various types of data. The storage 254 stores programs to be executed by the CPU 251 and further functions as a temporary storage area and a working memory while the relay conveyance unit 115 is in operation. A discharge unit 253 takes charge of control on a discharge operation. The accessory I/F 250 communicates with the printing apparatus 101, the inspection unit 106, the large-capacity stacker 107, and the finisher 116 via the cable 225.

Next, a configuration of the finisher 116 will be described.

A CPU 261 takes charge of, for example, control on and computation of each unit inside the finisher 116 via a system bus 265 by deploying a program stored in a storage 264 to a RAM 262 and executing the program. The RAM 262 is a type of a general volatile storage apparatus that can be directly accessed from the CPU 261, and is used as a working area for the CPU 261 and a temporary storage area for various types of data. The storage 264 stores programs to be executed by the CPU 261 and further functions as a temporary storage area and a working memory while the finisher 116 is in operation. A post-processing unit 263 takes charge of, for example, such post-processing operations as book binding, stitching, stapling, and folding. The accessory I/F 260 communicates with the printing apparatus 101, the inspection unit 106, the large-capacity stacker 107, and the relay conveyance unit 115 via the cable 225.

Next, a configuration of the inspection apparatus 108 will be described.

A CPU 226 takes charge of, for example, control on and computation of each unit inside the inspection apparatus 108 via a system bus 230 by deploying a program stored in a storage 228 to a RAM 227 and executing the program. The RAM 227 is a type of a general volatile storage apparatus that can be directly accessed from the CPU 226, and is used as a working area for the CPU 226 and a temporary storage area for various types of data. The storage 228 stores programs to be executed by the CPU 226 and further functions as a temporary storage area and a working memory while the inspection apparatus 108 is in operation. A display unit 245 is, for example, a display connected to the inspection apparatus 108, and accepts a user's input to the inspection apparatus 108 and displays a state of the inspection apparatus 108. The inspection unit I/F 229 exchanges various types of information with the inspection unit 106 via the cable 114.

Next, a configuration of the information processing apparatus 109 will be described.

A CPU 234 executes, for example, control on and computation of each unit inside the information processing apparatus 109 via the system bus 239 by deploying a program stored in a storage 236 to a RAM 235 and executing the program. The RAM 235 is a type of a general volatile storage apparatus that can be directly accessed from the CPU 234, and is used as a working area for the CPU 234 and a temporary storage area for various types of data. The storage 236 stores programs to be executed by the CPU 234 and further functions as a temporary storage area and a working memory while the information processing apparatus 109 is in operation. A NW I/F 237 is connected to a NW I/F 240 of the client computer 110 via the network 113. Also, the information processing apparatus 109 communicates with the client computer 110 via the NW I/F 237 and the NW I/F 240. A PDL analysis unit 231 reads in, for example, such PDL data as PDF, PostScript, and PCL received from the client computer 110, and executes processing for interpreting the same. A display unit 232 is, for example, a display connected to the information processing apparatus 109, and accepts a user's input to the information processing apparatus 109 and displays a state of the information processing apparatus 109.

Note that although the first embodiment will be described using a mode in which the information processing apparatus 109 and the inspection apparatus 108 do not communicate with each other, the mode of the first embodiment is merely an example. For example, it is permissible to adopt a mode in which the inspection apparatus 108 includes a NW I/F, and the information processing apparatus 109 communicates with the inspection apparatus 108 via this NW I/F and the NW I/F 237.

Next, a configuration of the client computer 110 will be described.

A CPU 243 takes charge of, for example, control on and computation of each unit inside the client computer 110 via a system bus 246 by deploying a program stored in a storage 244 to a RAM 242 and executing the program. The RAM 242 is a type of a general volatile storage apparatus that can be directly accessed from the CPU 243, and is used as a working area for the CPU 243 and a temporary storage area for various types of data. The storage 244 stores programs to be executed by the CPU 243 and further functions as a temporary storage area and a working memory while the client computer 110 is in operation. The NW I/F 240 communicates with the information processing apparatus 109 via the network 113.

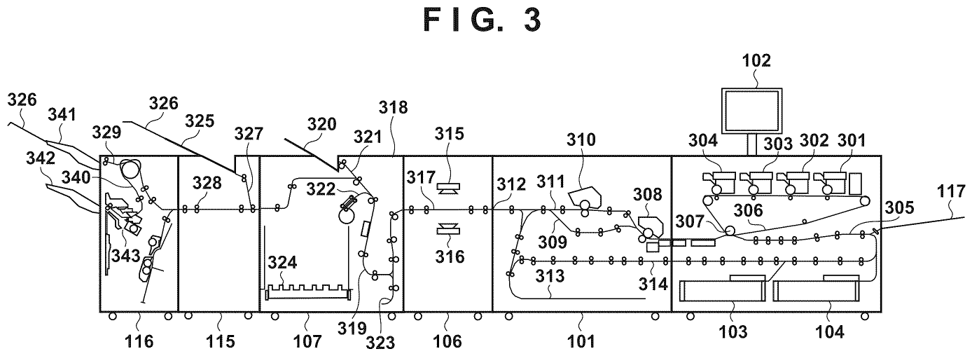

FIG. 3 is a schematic cross-sectional diagram for describing mechanisms of the printing apparatus 101, the inspection unit 106, the large-capacity stacker 107, the relay conveyance unit 115, and the finisher 116 according to the first embodiment.

The printing apparatus 101 accepts a user's input, and displays a printing status, device statuses, and the like, via the UI panel 102. Various types of sheets can be contained in the feed decks 103 and 104. In each feed deck, only one topmost sheet among the contained sheets can be separated and conveyed to a sheet conveyance path 305. In order to form a color image, development stations 301 to 304 respectively form toner images using colored toners of Y, M, C, and K, respectively. The toner images formed here are duplicated and transferred to an intermediate transfer belt 306 as a color image in the form of primary transfer. The intermediate transfer belt 306 rotates clockwise in the diagram, and the color toner image is transferred at a secondary transfer position 307 to a sheet that has been conveyed on the sheet conveyance path 305. A fixing unit 308 includes a pressurizing roller and a heating roller, and fixes the color image on the sheet by melting and pressure-bonding the toners while the sheet is passing between the rollers. The sheet that has passed through the fixing unit 308 is conveyed to a conveyance route 312 via a sheet conveyance path 309. In a case where further melting and pressure-bonding are required for the fixing depending on the type of the sheet, the sheet is conveyed to a second fixing unit 310 using an upper sheet conveyance path after passing through the fixing unit 308, additional melting and pressure-bonding are performed on the sheet, and then the sheet is conveyed to the conveyance route 312 via a sheet conveyance path 311. In a case where an image forming mode is double-sided printing, the sheet for which fixing has been performed is conveyed to a sheet inversion path 313, inverted, and then conveyed to a double-sided printing conveyance path 314, and image transfer is performed on a second side of the sheet at the secondary transfer position 307.

Next, the inspection unit 106 will be described.

CISs 315 and 316 are arranged inside the inspection unit 106 in such a manner that they oppose each other. The CIS 315 and the CIS 316 are respectively sensors for reading an upper side and a lower side of the sheet. The inspection unit 106 scans the sheet using the CISs 315 and 316 at a timing when the sheet that has been conveyed on a sheet conveyance path 317 arrives at a predetermined position. Image data obtained through this scan is transmitted to the inspection apparatus 108 via the inspection apparatus I/F 215 and the inspection unit I/F 229. The CPU 226 of the inspection apparatus 108 determines whether this received image data has a defect, and notifies the inspection unit 106 of the determination result via the inspection unit I/F 229 and the inspection apparatus I/F 215 again. The CPU 216 of the inspection unit 106 notifies the large-capacity stacker 107, the relay conveyance unit 115, and the finisher 116 of the received determination result via the accessory I/Fs 214, 220, 250, and 260. Furthermore, the printing apparatus 101 may also be notified via the accessory I/Fs 214 and 208.

Next, the large-capacity stacker 107 on which a large number of sheets can be stacked will be described.

The large-capacity stacker 107 has a main body 318 including the main tray 324 as a tray for stacking sheets and a top tray 320 as a discharge tray arranged atop the main body 318. Sheets that have passed through the inspection unit 106 enter the large-capacity stacker 107 via the sheet conveyance path 317. The sheets that have been thus conveyed are stacked on the main tray 324 from a sheet conveyance path 319 via a sheet conveyance path 322. In a case where the sheets are to be output to the top tray 320, the CPU 221 of the large-capacity stacker 107 conveys the sheets to the top tray 320 from the sheet conveyance path 319 via a sheet conveyance path 321. An inversion unit 323 is an inversion unit for inverting the sheets. This inversion unit 323 is used in a case where the sheets are to be stacked on the main tray 324. In a case where the sheets are to be stacked on the main tray 324 so that the direction of the sheets that have entered and the direction of the sheets during stacking are the same, the inversion unit 323 inverts the sheets once. Also, in a case where the sheets are to be conveyed to the top tray 320, the inversion unit 323 does not perform the inverting operation as the sheets are discharged as is without being flipped during stacking.

Next, the relay conveyance unit 115 will be described.

The sheets that have been inspected by the inspection unit 106 can be discharged to the top tray 325 via the sheet conveyance path 327. A long tray 326, which will be described later, can be additionally installed on the top tray 325. By installing this long tray 326, a sheet that has a larger length than a standard-sized sheet in a conveyance direction, for example, a long sheet of 1 m or more, can be discharged without a stacking error.

Next, the finisher 116 will be described.

The finisher 116 applies finishing processing to sheets conveyed via a sheet conveyance path 328 of the relay conveyance unit 115 in accordance with a function designated by a user. The finisher 116 specifically has such finishing functions as stapling (binding at one section or two sections), punching (two holes or three holes), and saddle stitch bookbinding. The finisher 116 includes two discharge trays 341 and 342, and discharges sheets to the discharge trays via a sheet conveyance path 329. Note that, on the sheet conveyance path 329, such processing as stapling cannot be performed. In a case where such processing as stapling is to be performed, a processing unit 343 executes a finishing function designated by the user via a sheet conveyance path 340, and outputs the sheets to the discharge tray 342. Each of the discharge trays 341 and 342 can ascend and descend; it is also possible to perform an operation in which the sheets to which the processing unit 343 has applied the finishing processing are stacked on the discharge tray 341 by causing the discharge tray 341 to descend. Note that the long tray 326 can also be installed on the discharge tray 341. By installing the long tray 326, a long sheet can be discharged and held without a stacking error, similarly to the relay conveyance unit 115.

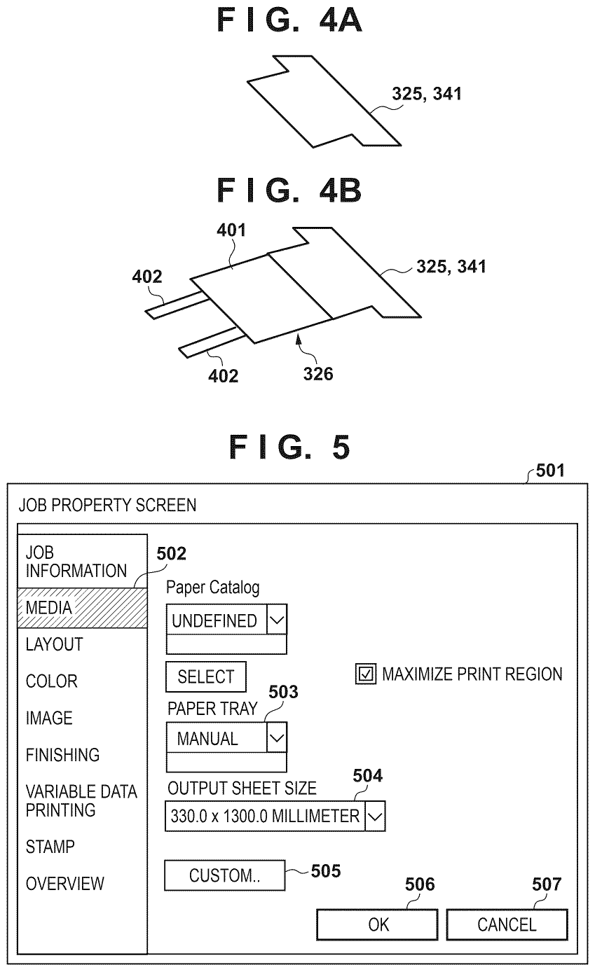

FIGS. 4A and 4B are diagrams for describing the long tray 326 according to the first embodiment.

FIG. 4A shows the top tray 325 of the relay conveyance unit 115 and the discharge tray 341 of the finisher 116 to which the long tray 326 (FIG. 3) can be attached. Note that the long tray 326 may be similarly attachable to other trays. The following description will be provided using an example in which the long tray 326 can be additionally mounted on the top tray 325 of the relay conveyance unit 115 and the discharge tray 341 of the finisher 116.

FIG. 4B shows a state where the long tray 326 has been attached to the top tray 325 and the discharge tray 341. An extension tray unit 402 is stored in a long tray base unit 401, and a longer sheet can be stacked by drawing out the extension tray unit 402 as shown in FIG. 4B.

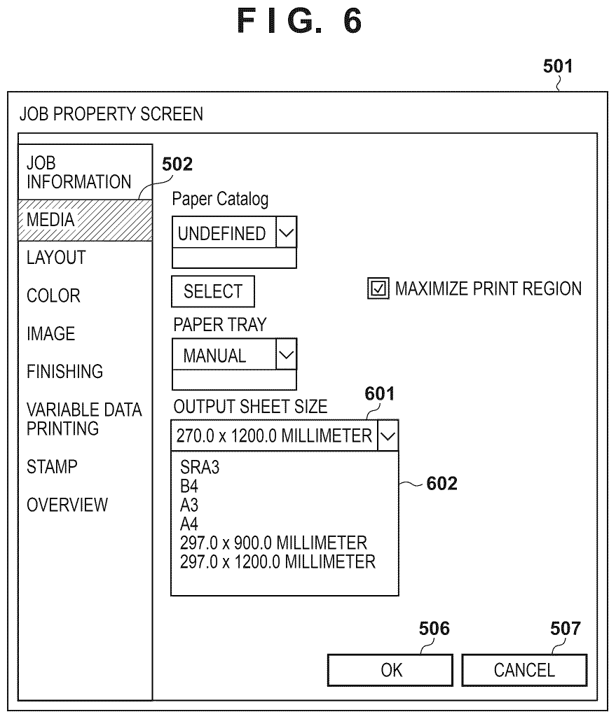

FIG. 5 to FIG. 7 depict views showing an example of an operation screen displayed on the display unit 232 of the information processing apparatus 109 according to the first embodiment.

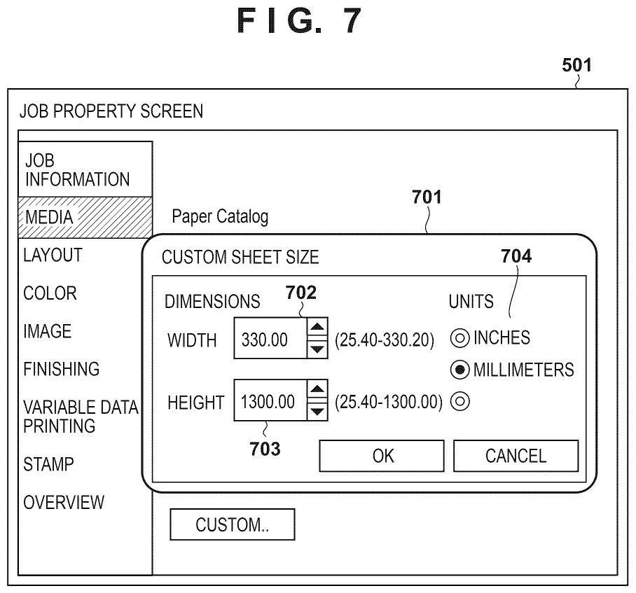

The screens of FIG. 5 and FIG. 6 represent a job property screen 501 for setting various types of conditions of a print job. The number of various types of conditions of a print job is large, and buttons are displayed on the left side of the screen in such a manner that they are grouped into categories. When a user has pressed a medium button 502, an operation screen for configuring settings related to printing sheets is displayed as shown in FIGS. 5 to 7. A sheet size to be used in printing is displayed by an output sheet size 504.

Also, in a case where a sheet size is to be changed, a size list 602 is displayed by pressing an output sheet size selection button 601 as shown in FIG. 6, and thus the user can select a sheet size that the user wishes to use from the size list 602.

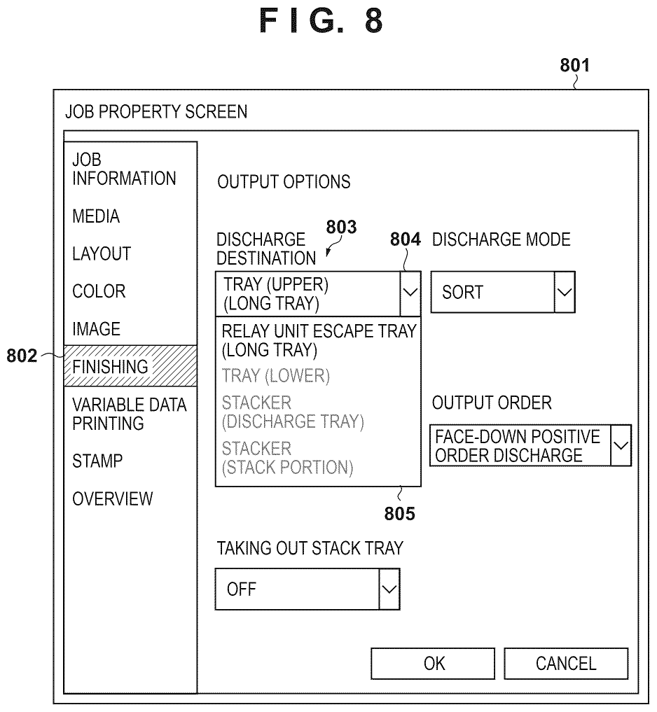

Furthermore, in a case where the user wishes to print on a sheet of a size that is not included in the size list 602, a custom sheet size dialog 701 of FIG. 7 is displayed by pressing a custom button 505 of FIG. 5. A custom sheet size can be input and set by selecting a unit of length using unit selection checkboxes 704, inputting a sheet width to an input area 702, inputting a sheet height to an input area 703, and pressing an OK button. The sheet width and the sheet height that have been thus set are saved in a nonvolatile memory of the storage 236 by pressing an OK button 506. Also, in a case where all of the values that have been input via this screen are to be cancelled and not saved, the user presses a cancel button 507.

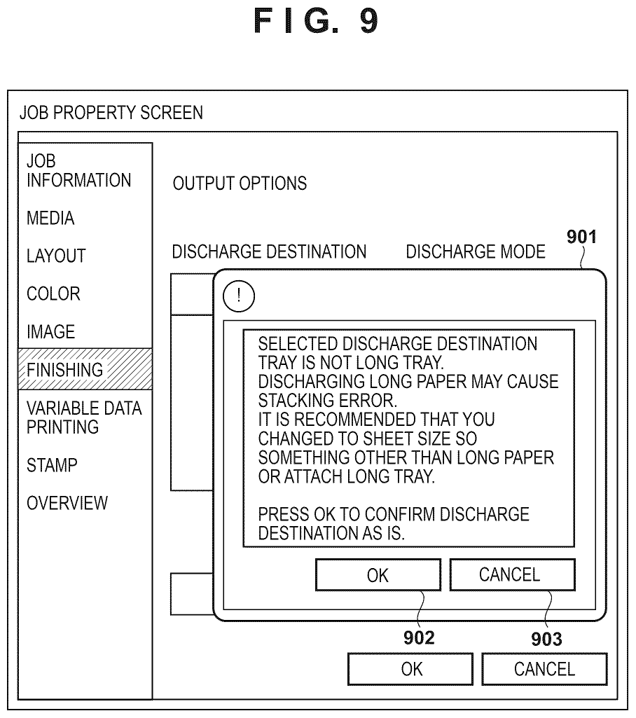

FIG. 8 is a diagram showing an example of an operation screen for inputting job properties that is displayed on the display unit 232 of the information processing apparatus 109 according to the first embodiment.

On this operation screen 801, a finishing button 802 on the left part of the screen has been selected, and finishing-related setting items are displayed on the right side thereof. A discharge destination 803 can designate to which destination a printed sheet is discharged. In FIG. 8, the discharge tray 341 of the finisher 116 has been selected as a discharge destination, and the long tray 326 has been attached to this discharge tray 341. Therefore, “tray (upper) (long tray)” is displayed under the discharge destination 803. Here, in a case where the discharge destination is to be changed, the user causes a discharge destination selection candidate list 805 to be displayed by pressing a discharge destination selection button 804. This discharge destination selection candidate list 805 displays a list of trays to which sheets printed by the printing apparatus 101 can be discharged.

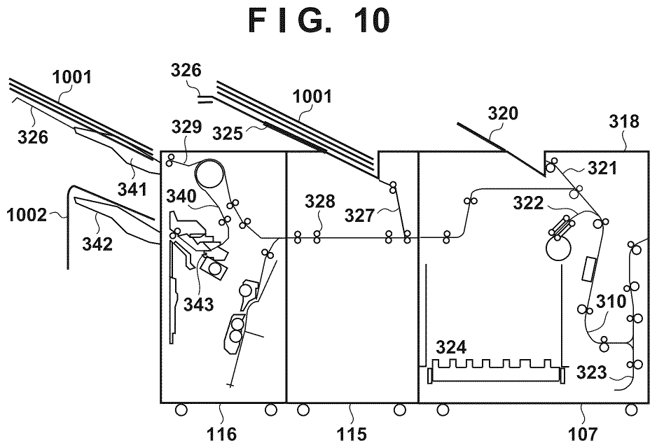

In FIG. 8, two trays, namely the tray (upper) and the top tray of the relay conveyance unit (relay unit) 115 are displayed in a normal font color; this indicates that these trays are discharge destinations that are recommended as discharge destinations of long sheets. Also, the characters “long tray” are additionally displayed next to the names of these discharge destinations, which makes is possible to distinguish that the long tray 326 has been attached to these trays. Furthermore, in the discharge destination selection candidate list 805, other discharge destination candidates to which the long tray 326 has not been attached are displayed in a font color of gray. This is because a long sheet of 297.0×1200.0 mm has been selected as the output sheet size on the operation screen of FIG. 6. That is to say, in a case where a tray that is a discharge destination to which long sheets are discharged is a normal tray to which the long tray has not been attached, there is a possibility of a stacking error, such as a displacement in a stacking position and falling of sheets. For this reason, a tray that is suitable for stacking these long sheets and a tray that is not suitable for stacking these long sheets are identifiably displayed, thereby preventing recommendation of a selection of tray that is not suitable for stacking of long sheets. Also, when the user has selected an unrecommended tray at the time of execution of a job that uses long sheets, a warning dialog 901 shown in FIG. 9 is displayed as a pop-up.

FIG. 9 depicts a view showing an example of a warning screen that is displayed when an unrecommended tray has been selected at the time of execution of a job that uses long sheets.

The warning dialog 901 displays a message indicating that there is a possibility that a stacking error of long sheets occurs with the selected tray. Also, the dialog 901 provides an instruction to change the sheet size to a size other than the long size, or to attach a long tray to the tray that has been selected as a discharge destination, as a solution for solving the cause of this warning. Furthermore, alternatively, the dialog 901 may provide an instruction to select a tray to which a long tray has been attached. When a cancel button 903 has been pressed, the discharge destination tray selected by the user is cancelled. Also, when the user wishes to decide on the discharge destination as selected despite the displayed warning, the user presses an OK button 902. In this way, it is also possible to select a tray to which a long tray has not been attached as a discharge destination at the time of execution of a job that uses long sheets.

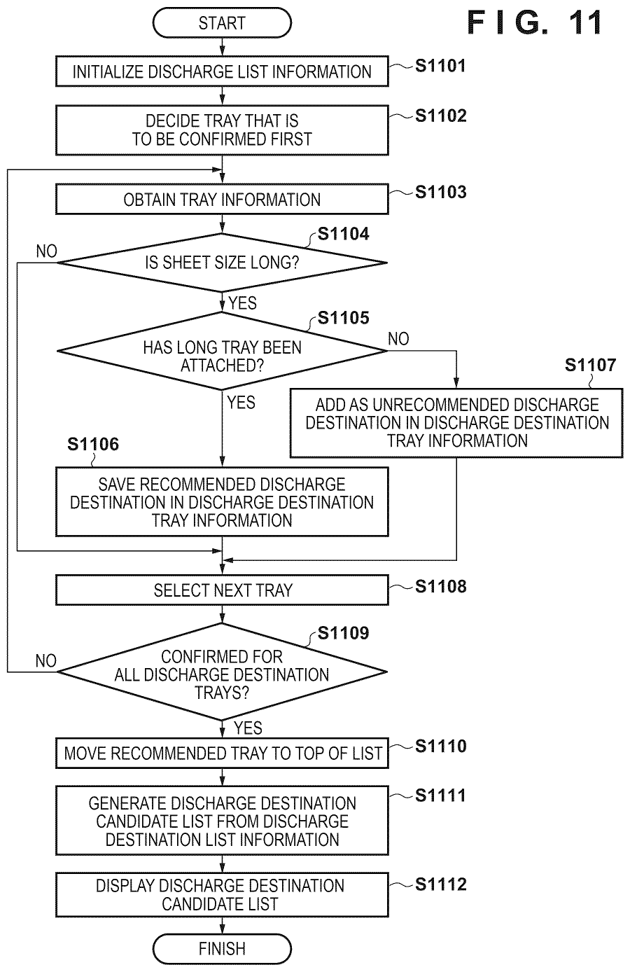

FIG. 10 is a diagram showing an example of a stacked state when long sheets have been discharged to each tray. Note, parts that are the same as those of FIG. 3 are given the same reference numerals thereas in FIG. 10, and a description thereof is omitted.

FIG. 10 shows a state where the long tray 326 has been attached to the top tray 325 of the relay conveyance unit 115 and the discharge tray 341 of the finisher 116, and the long tray 326 has not been attached to the discharge tray 342 of the finisher 116. Therefore, the top tray 325 and the discharge tray 341 have a length that is sufficient for stacking of long paper, namely long sheets 1001. On the other hand, as the long tray 326 has not been attached to the discharge tray 342, a leading portion of a long sheet 1002 excessively sticks out of the tray 342 when the sheet is discharged. In this case, there is a possibility that the long sheet 1002 falls from the discharge tray 342 and the sheet 1002 becomes damaged or stained. Therefore, display of the aforementioned warning dialog 901 of FIG. 9 has an advantageous effect where the user can reliably know which one is a discharge tray that is appropriate as a discharge destination of long sheets, and the occurrence of a problem caused by a stacking error of long sheets can be prevented in advance.

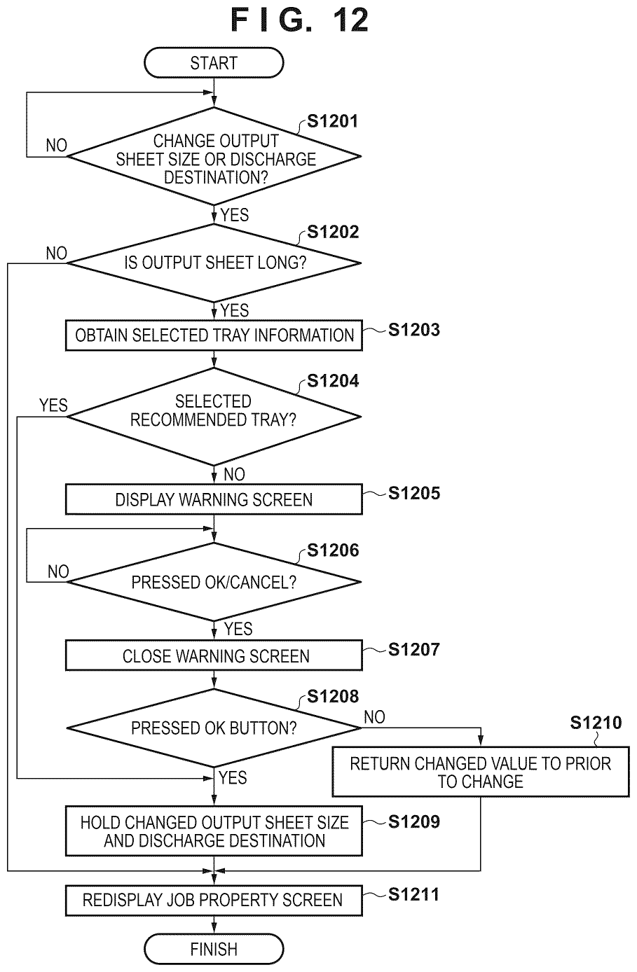

Next, processing of the information processing apparatus 109 for displaying a discharge destination list according to the first embodiment will be described with reference to a flowchart of FIG. 11.

FIG. 11 is a flowchart for describing processing by the information processing apparatus 109 for displaying a discharge destination list according to the first embodiment. Note that processing described by this flowchart is realized by the CPU 234 of the information processing apparatus 109 deploying a program stored in the storage 236 to the RAM 235 and executing the program. Also, processing described by this flowchart is started when the discharge destination selection button 804 of FIG. 8 has been pressed.

First, in step S1101, the CPU 234 initializes, for example, discharge destination list information in the RAM 235, which stores information for displaying a discharge destination list of the image forming system in which a job is to be executed. This discharge destination list information is a data table that is generated by the CPU 234 in the RAM 235 in order to display the discharge destination selection candidate list 805 shown in FIG. 8. Next, the processing proceeds to step S1102, and the CPU 234 selects a tray that is to be confirmed first from among a plurality of trays that have a possibility of becoming a discharge destination (e.g., the trays 320, 325, 341, and 342). Then, the processing proceeds to step S1103, and the CPU 234 obtains tray information of this selected tray. This tray information includes, for example, information indicating whether the long tray 326 has been attached to this tray and the like.

Next, the processing proceeds to step S1104, and the CPU 234 determines whether an output sheet size of the job to be executed from now is long; if the output sheet size is long, the processing proceeds to step S1105, and the CPU 234 determines whether the long tray 326 has been attached to the tray of the tray information obtained in step S1103. On the other hand, when the output sheet size of the job is not long in step S1104, the processing proceeds to step S1108. When the CPU 234 has determined that the long tray 326 has been attached to this tray in step S1105, the processing proceeds to step S1106, the CPU 234 saves this tray as a recommended tray in the discharge destination list information, and the processing proceeds to step S1108. Also, in a case where it has been determined that the long tray 326 has not been attached to this selected tray in step S1105, the processing proceeds to step S1107, the CPU 234 saves this tray as an unrecommended tray in the discharge destination list information, and the processing proceeds to step S1108. In step S1108, the CPU 234 selects the next tray from among the plurality of trays, and the processing proceeds to step S1109. In step S1109, the CPU 234 determines whether the foregoing confirmation processing has been executed with respect to all of the foregoing plurality of trays; when processing for all of the trays has not finished, the processing proceeds to step S1103, and the CPU 234 executes processing similar to the foregoing. Once the CPU 234 has confirmed all of the trays in step S1109 in this way, the processing proceeds to step S1110, and the CPU 234 moves tray information that has been saved as a recommended tray to the top of the discharge destination list.

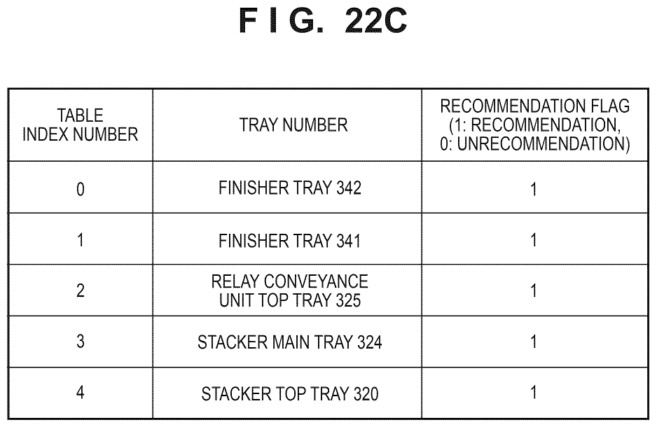

FIG. 22A is a diagram showing an example of discharge destination list information that has been generated in the configuration shown in FIG. 10.

In the example of FIG. 10, the top tray 325 of the relay conveyance unit 115 and the discharge tray 341 of the finisher 116 have the long tray 326 attached thereto, and are thus registered as recommended discharge destination trays.

Next, the processing proceeds to step S1111, and the CPU 234 generates a discharge destination selection candidate list from this discharge destination list information. At this time, a candidate is generated using black font if its recommendation flag in the data table is “1”, and is generated using gray font if its recommendation flag therein is “0”. Then, the processing proceeds to step S1112, and the CPU 234 displays the discharge destination selection candidate list generated in step S1111 on the display unit 232 of the information processing apparatus 109. An example of display at this time is, for example, the aforementioned discharge destination selection candidate list 805 shown in FIG. 8. This enables the user to easily differentiate recommended discharge trays and unrecommended discharge trays from each other.

As described above, according to this processing, in a case where an output sheet size of a job is long, the user can easily select a discharge tray to which a long tray has been attached as a discharge destination of an output sheet of the job. This can prevent, in advance, the occurrence of a problem in an output sheet caused by a stacking error of long sheets on a discharge tray to which a long tray has not been attached.

Next, a description is given of processing for displaying a warning screen upon selection of an unrecommended tray when a user selects a discharge destination tray on the information processing apparatus 109 according to the first embodiment.

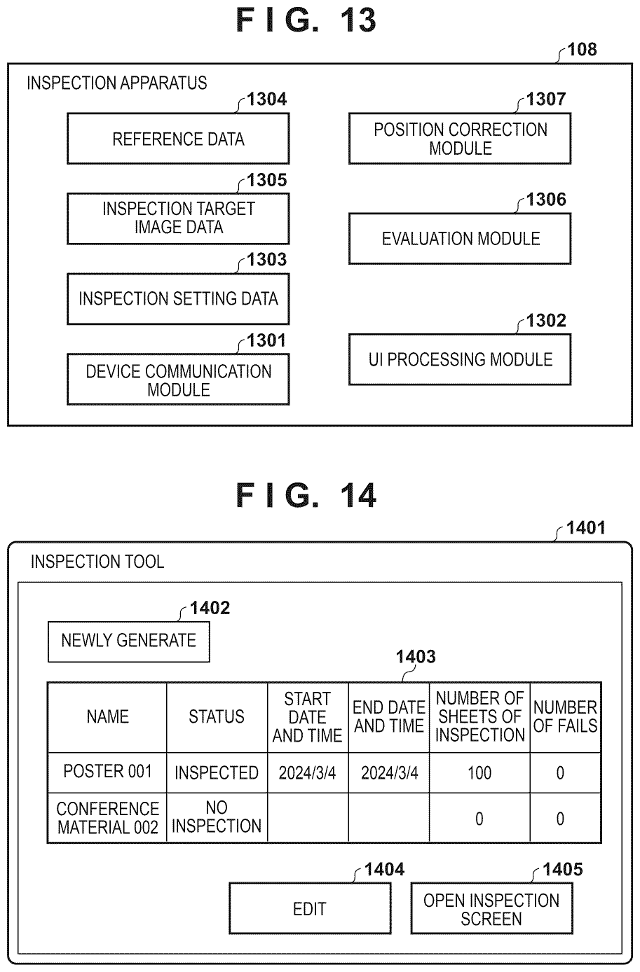

FIG. 12 is a flowchart for describing processing for displaying a warning screen upon selection of an unrecommended tray when the user selects a discharge destination tray on the information processing apparatus 109 according to the first embodiment. Note that processing described by this flowchart is realized by the CPU 234 of the information processing apparatus 109 deploying a program stored in the storage 236 to the RAM 235 and executing the program. Also, processing described by this flowchart is started when, for example, the job property screen of FIG. 5 has been displayed.

First, in step S1201, the CPU 234 waits for the user to change an output sheet size or a discharge destination. When a change in one of the output sheet size and the sheet discharge destination has been detected, the processing proceeds to step S1202, and the CPU 234 determines whether an output sheet of a job is long. If it has been determined here that the output sheet is long, the processing proceeds to step S1203; otherwise, the processing proceeds to step S1211. In step S1203, the CPU 234 reads out and obtains information of the discharge destination selected by the user. Then, the processing proceeds to step S1204, and the CPU 234 determines whether the discharge destination tray selected by the user is a recommended tray. If it has been determined that the selected discharge destination tray is a recommended tray, the processing proceeds to step S1209, and the CPU 234 holds information of the output sheet size and the discharge destination selected by the user as information changed by the user.

On the other hand, in a case where it has been determined that the tray selected by the user is an unrecommended tray in step S1204, the processing proceeds to step S1205, and the CPU 234 displays, for example, the aforementioned warning dialog 901 of FIG. 9. Then, the processing proceeds to step S1206, and the CPU 234 waits for the OK button 902 or the cancel button 903 to be pressed on the warning dialog 901. When the OK button 902 or the cancel button 903 has been pressed, the processing proceeds to step S1207, and the CPU 234 closes the warning dialog 901. Then, the processing proceeds to step S1208, and the CPU 234 determines whether the user has pressed the OK button 902. When it has been determined that the OK button 902 has been pressed, the processing proceeds to step S1209, and the CPU 234 keeps holding the information of the output sheet size and the discharge destination selected by the user as is without changing the same, and the processing proceeds to step S1211. As a result, in a case where the output sheet of the job is long, the user can decide a discharge tray to which a long tray has not been attached as a discharge destination with a recognition of the warning.

On the other hand, in a case where the CPU 234 has determined that the cancel button 903 has been pressed in step S1208, the processing proceeds to step S1210, and the CPU 234 cancels the information of the sheet size and the discharge destination that were changed by the user in step S1201, restores the information to information prior to the change made by the user, and the processing proceeds to step S1211. Then, in step S1211, the CPU 234 displays, for example, the job property screen shown in FIG. 8 again, and ends the present processing.

As described above, according to the present processing, when the user has selected a discharge tray to which a long tray has not been attached as a discharge destination of an output sheet of a job in a case where an output sheet size of the job is long, a warning about this selection can be issued. Also, the user can change a discharge destination tray or an output sheet size in conformity with this warning, or can execute the job using the discharge destination tray and the output sheet size intended by the user without changing them.

As described above, according to the first embodiment, a long printed material can be discharged to an appropriate discharge tray. This can prevent the occurrence of a problem caused by a stacking error of long sheets on a discharge tray.

### Second Embodiment

The above first embodiment has been described in relation to long-sheet printing processing in a print job managed by the information processing apparatus 109. The inspection apparatus 108 can also be connected to the image forming system according to embodiments. Then, printed sheets that have passed an inspection of the inspection apparatus 108 are discharged to a tray which has been designated by the information processing apparatus 109 and which has been selected on the discharge destination display section 803 of FIG. 8. On the other hand, printed sheets that have failed the inspection are discharged as inspection error sheets to a discharge destination different from the discharge destination of the printed sheets that have passed the inspection. In view of this, a second embodiment will be described in relation to designation of a discharge destination of long sheets for which an inspection for long sheets has been executed and which have failed the inspection. Note that the configuration of the image forming system, the hardware configuration of each apparatus, and the like according to the second embodiment are similar to those of the above-described first embodiment, and thus a description thereof is omitted.

First, an inspection function of the inspection apparatus 108 according to the second embodiment will be described.

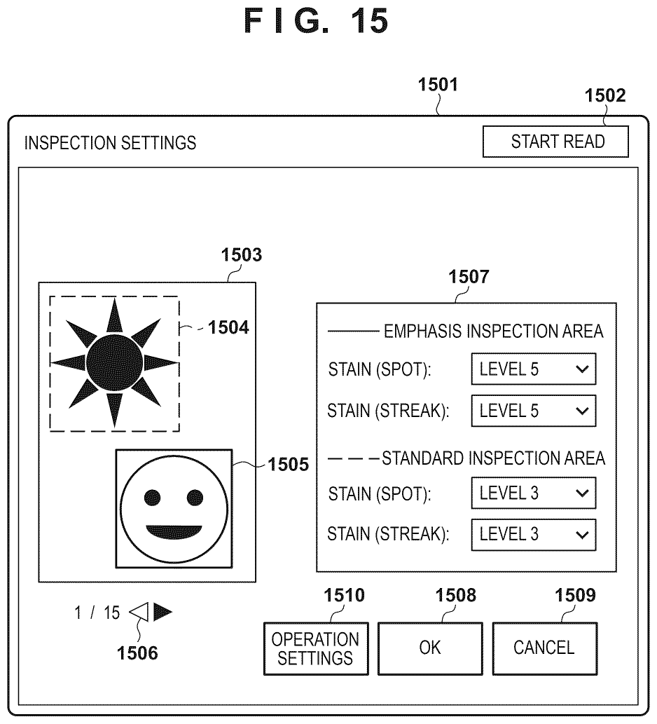

FIG. 13 is a functional block diagram for describing the functions of the inspection apparatus 108 according to the second embodiment. Note that these functions are realized by the CPU 226 of the inspection apparatus 108 deploying a program stored in the storage 228 to the RAM 227 and executing the program.

A device communication module 1301 communicates with the inspection unit 106 via the inspection unit I/F 229. It causes the imaging unit 218 mounted on the inspection unit 106 to read a sheet that has been printed for inspection, and receives the sheet as image data. Also, the device communication module 1301 notifies the inspection unit 106 of an inspection result, and the printing apparatus 101 receives the inspection result from the inspection unit 106 and changes a discharge destination of the inspected sheet in accordance with this result. A UI processing module 1302 displays a state of an inspection job, and accepts, for example, an input of inspection conditions from a user. Inspection setting data 1303 is a value of, for example, a threshold that determines passing and failing in the inspection. Reference data 1304 is reference image data that is a ground truth image used in the inspection. This reference image data may be loaded as image data obtained by the inspection unit 106 reading a sheet of the ground truth image, or may be received RIP data generated by the information processing apparatus 109. Inspection target image data 1305 is image data of a printed sheet that the inspection unit 106 has read using the imaging unit 218 at the time of execution of the inspection. An evaluation module 1306 compares the reference data 1304 with the inspection target image data 1305, and determines whether the image printed on the sheet satisfies an inspection criterion based on the inspection setting data 1303. For example, in a case where the content of the inspection is “stain (spot) detection), the evaluation module 1306 determines that the inspection is passed in a case where a size of a spot that is not present in the image of the reference data 1304 and is present in the inspection target image data 1305 is equal to or smaller than a determination threshold, and determines that the inspection has failed in a case where the size exceeds the threshold. Note that there are cases where the inspection target image data received from the inspection unit 106 is inclined or displaced due to the influence of a sheet conveyance state. A position correction module 1307 uses an image that has been corrected by rotating the image data read by the imaging unit 218 and/or moving coordinates therein as the inspection target image data 1305.

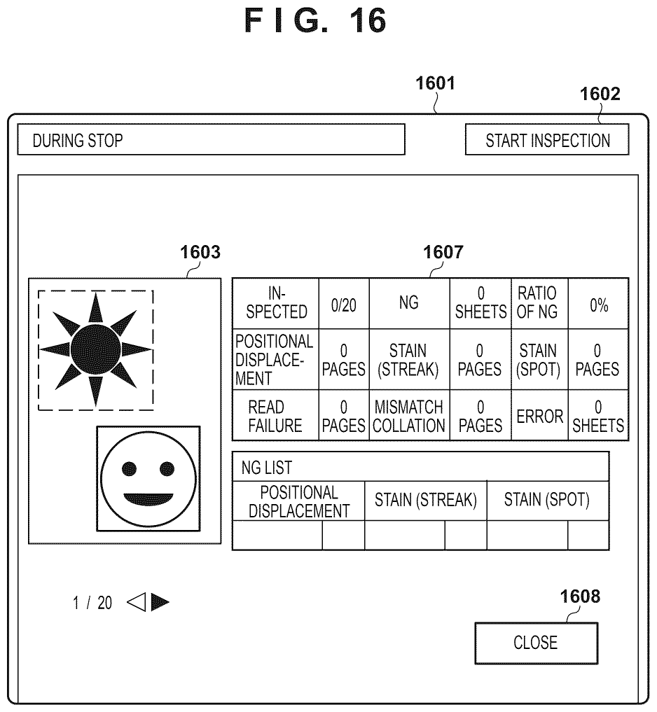

FIG. 14 depicts a view showing an example of a main screen 1401 that is displayed on the display unit 245 of the inspection apparatus 108 according to the second embodiment.

A list 1403 of pieces of inspection target data that have already been registered is displayed at the center of the main screen 1401. FIG. 14 shows an example in which there are inspected data with a name “poster 001”, and uninspected data with a name “conference material 002”. To newly generate inspection target data, the user presses a newly generate button 1402. Also, to select existing inspection target data from, for example, the list 403 and edit this data, the user selects the inspection target data and presses an edit button 1404. Furthermore, to execute the inspection, the user presses an “open inspection screen” button 1405.

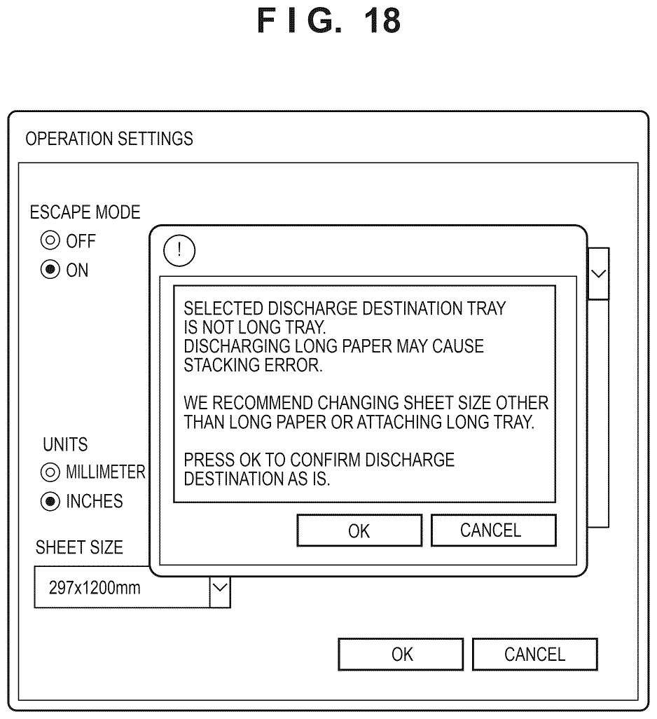

FIG. 16 depicts a view showing an example of an inspection screen 1601 that is displayed on the display unit 245 when the inspection has been stopped, or before the inspection is started.

When an inspection start button 1602 has been pressed in this state, this state transitions to an inspection state, and an inspection for comparing a reference image displayed on a reference image display area 1603 with an image of a printed sheet is performed. An inspection result 1607 is an area that displays an inspection result based on, for example, comparison between reference data and inspection target image data; in the present example, the inspection result 1607 shows a state where a positional displacement, a reading failure, a failure in the inspection, and the like have not occurred. A close button 1608 is a button that provides an instruction for closing the present screen and making a transition to a previous screen.

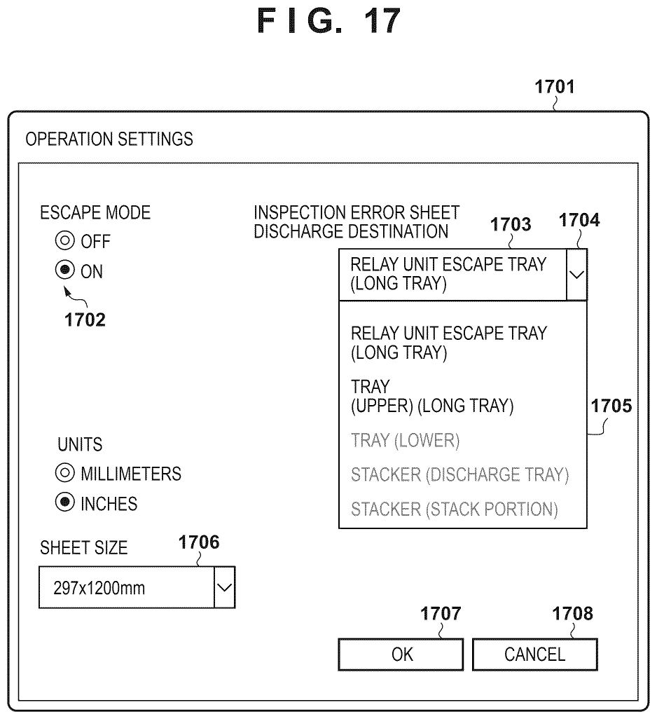

When the newly generate button 1402 or the edit button 1404 of FIG. 14 has been pressed, an inspection setting screen 1501 of FIG. 15 is displayed.

FIG. 15 depicts a view showing an example of the inspection setting screen 1501 that is displayed on the display unit 245 of the inspection apparatus 108 according to the second embodiment.

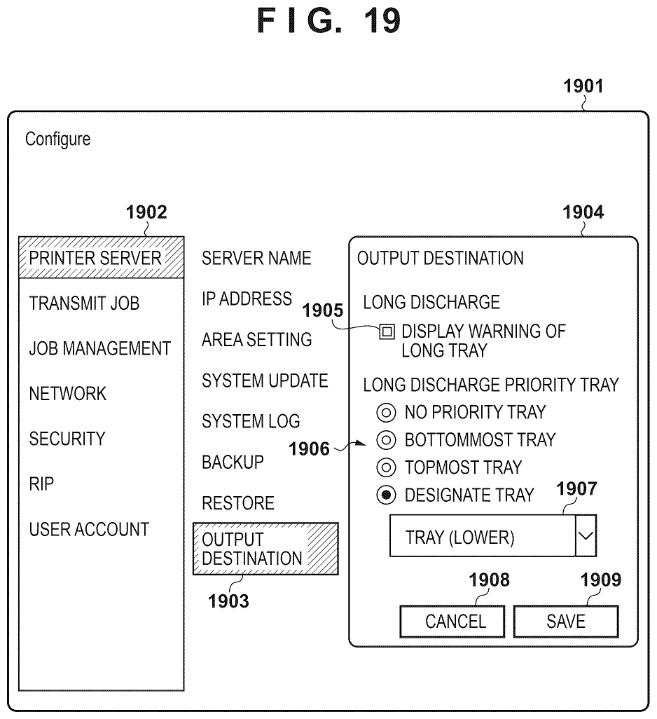

A read start button 1502 causes the inspection unit 106 to read a sheet on which a ground truth image has been printed, and obtains this scanned image as a reference image. Also, the reference image may be obtained as RIP data from the information processing apparatus 109. A reference image display area 1503 displays the obtained reference image. Buttons 1506 are buttons for selecting a reference image to be displayed in the reference image display area 1503 in a case where there are a plurality of reference images. In FIG. 15, the first reference image included among 15 reference images is displayed. The user can set inspection target areas by designating positions on this displayed reference image. For example, an emphasis inspection area 1505 and a standard inspection area 1504 can be designated as these inspection target areas. Then, with respect to each area, inspection levels of a point stain and a streak stain can be designated. Numerical values of the inspection levels are set so that the larger the numerical values, the more precise the performed inspection. Therefore, the inspection levels of larger numerical values cause a smaller point and a thinner streak to be determined as failures. In an inspection level display area 1507, a point stain and a streak stain are inspection targets in each of the emphasis inspection area 1505 and the standard inspection area 1504, and an inspection level of “5” is set for the emphasis inspection area 1505. Also, for the standard inspection area 1504, an inspection level of “3” is set, which is a lower degree of preciseness of inspection than that for the emphasis inspection area 1505. An OK button 1508 is a button for providing an instruction for enabling and saving the settings on this screen, and a cancel button 1509 is a button for providing an instruction for disabling the settings on this screen and making a transition to an original screen. An operation setting button 1510 designates an operation of the inspection apparatus 108 at the time of execution of the inspection, and an operation setting screen of FIG. 17 is displayed when this operation setting button 1510 has been pressed.

FIG. 17 depicts a view showing an example of an operation setting screen 1701 that is displayed on the display unit 245 of the inspection apparatus 108 according to the second embodiment.

On this operation setting screen 1701, setting information necessary for the inspection can be input and confirmed. An escape mode is a mode for separating sheets that have failed the inspection from sheets that have passed the inspection. When radio buttons 1702 of the escape mode have been set to ON, sheets that have passed the inspection and sheets that have failed the inspection can be separately discharged to their respective, designated discharge destinations. When the radio buttons 1702 of the escape mode have been set to OFF, sheets that have failed the inspection are output to the same discharge destination as sheets that have passed the inspection. A sheet size 1706 sets a sheet size of a reference image that is a comparison target in the inspection. In FIG. 17, a long size of 297×1200 mm is selected. A discharge destination display section 1703 for inspection error sheets displays a tray to which inspection target sheets that have been determined to have an inspection error or have failed the inspection are to be discharged. In the example of FIG. 17, the top tray 325 of the relay conveyance unit (relay unit) 115 has been selected as a discharge destination of sheets that have failed the inspection. An OK button 1707 is a button for providing an instruction for enabling and saving the settings on this screen, and a cancel button 1708 is a button for providing an instruction for disabling the settings on this screen and making a transition to an original screen.

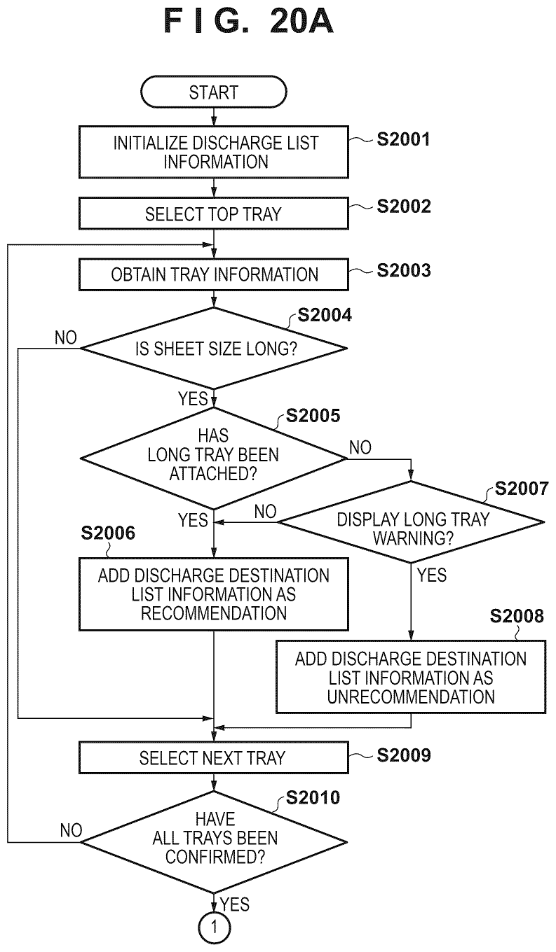

In a case where the user wishes to change the discharge destination of sheets that have failed the inspection in this state, the user causes a discharge destination selection candidate list 1705 for inspection error sheets to be displayed by pressing a discharge destination change button 1704. In the discharge destination selection candidate list 1705 for error sheets, trays to which the long tray 326 has not been attached are displayed using a gray font color, similarly to the discharge destination display section 803 of FIG. 8. This is because long paper of 297×1200 mm has been selected under the sheet size 1706 of FIG. 17. This is because, in the case of a tray to which the long tray 326 has not been attached, there is a possibility that a stacking error, such as a displacement in a sheet stacking position and falling of sheets, occurs when discharging long error sheets. That is to say, in a case where long paper has been selected, discharge trays to which the long tray 326 has not been attached are not recommended as discharge destinations to the user. Then, if the user mistakenly selects these unrecommended trays as discharge destinations, a warning dialog 1801 shown in FIG. 18 is displayed.

FIG. 18 depicts a view showing an example of a warning screen that is displayed when an unrecommended tray has been selected on the operation setting screen 1701. As the content of the screen of FIG. 18 is exactly the same as the warning dialog 901 of FIG. 9 according to the first embodiment, a description thereof is omitted.

Note that processing for displaying a list of discharge destinations of inspection error sheets and processing for displaying a warning screen at the time of selection of a discharge destination in the inspection apparatus 108 according to the second embodiment can be executed similarly to the flowcharts of FIG. 11 and FIG. 12 according to the first embodiment, and thus a description thereof is omitted.

As described above, according to the second embodiment, sheets that have been determined to have failed or have an error as a result of an inspection on long printed materials can be discharged to an appropriate discharge tray. This can prevent the occurrence of, for example, a stain on and bending of printed materials caused by a stacking error and the like of long printed materials that have determined to have failed or have an error.

### Third Embodiment

In the above-described first embodiment, a warning is displayed if a user attempts to select a tray to which a long tray has not been attached when selecting a discharge destination of long paper. However, there are cases where a warning need not be displayed. For example, there is a case where a board is placed under the tray 342 to prevent long sheets from falling from the tray without attaching the long tray 326. In such a case, a problem is not likely to occur even if the tray 342 is selected as a discharge destination of long paper. Therefore, it is desirable that whether to display such a warning is selectable on a case-by-case basis. In view of this, a third embodiment will be described using an example in which whether a warning is to be displayed is selectable in a case where the user has selected a tray to which a long tray has not been attached as a discharge destination of long paper. Note that the configuration of the image forming system, the hardware configuration of each apparatus, and the like according to the third embodiment are similar to those of the above-described first embodiment, and thus a description thereof is omitted.

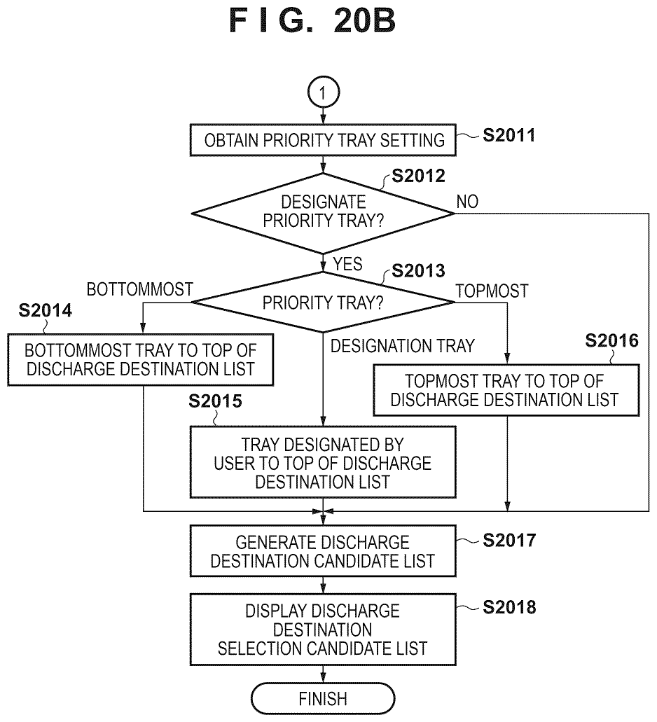

FIG. 19 depicts a view showing an example of an environment setting screen 1901 displayed on the display unit 232 of the information processing apparatus 109 according to the third embodiment. On this environment setting screen 1901, the user can select whether to display a warning upon selection of a tray to which a long tray has not been attached as a discharge destination of long paper.

The environment setting screen 1901 includes a plurality of setting items that are classified into categories. Category names are listed on the left side of the screen. Here, when a printer server 1902 and an output destination 1903 have been selected, an output destination setting dialog 1904 is displayed. This output destination setting dialog 1904 includes a plurality of setting items. A checkbox 1905 is a switch for selecting whether to display, for example, the warning dialog 901 shown in FIG. 9. Here, in a case where the checkbox 1905 has been unchecked, a warning is not displayed even if a tray to which a long tray has not been attached is selected as a discharge destination of long paper. Also, radio buttons 1906 for selecting a priority tray to which long paper is discharged have four options, and enable designation of a tray that is preferentially displayed in the discharge destination selection candidate list 805 of FIG. 8. FIG. 22B shows a relationship between the options of the radio buttons 1906 and priority display trays that are displayed in the discharge destination selection candidate list 805 of FIG. 8.

FIG. 22B shows trays that are preferentially displayed and the purposes of selection of these trays, in correspondence with the options of the radio buttons 1906 for selecting a discharge destination tray to which long paper is discharged.

The options of the radio buttons 1906 include four options: no priority tray, a bottommost tray, a topmost tray, and designate a tray. In the example of FIG. 19, a radio button corresponding to “designate a tray” has been selected. Also, a “tray (lower)” designated by the user is displayed as a priority tray 1907 to which long paper is discharged. When a save button 1909 has been pressed, the setting contents selected on this screen are saved in the storage 236; when a cancel button 1908 has been pressed, all of the contents selected on this screen are cancelled, and a previous screen is restored.

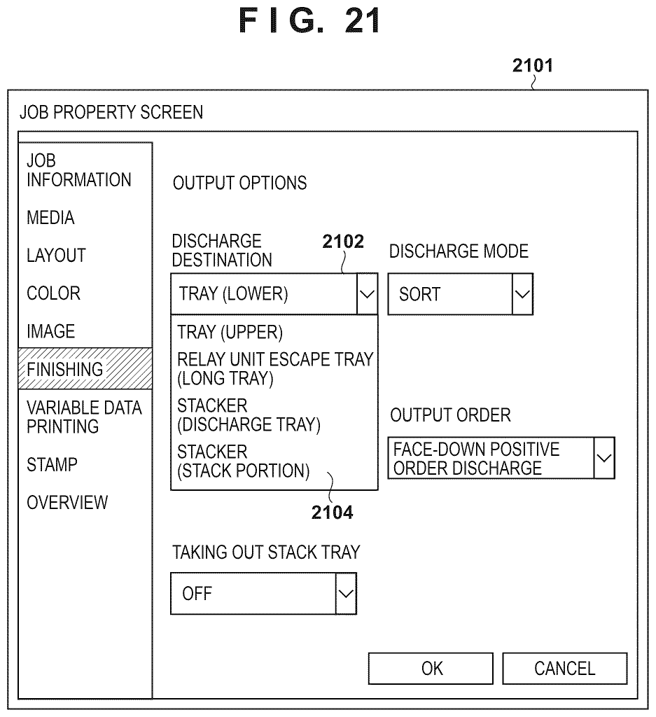

Next, processing of the information processing apparatus 109 for displaying a discharge destination list according to the third embodiment will be described using a flowchart of FIGS. 20A and 20B.

FIGS. 20A and 20B are flowcharts for describing processing by the information processing apparatus 109 for displaying a discharge destination list according to the third embodiment. Note that processing described by the flowcharts is realized by the CPU 234 of the information processing apparatus 109 deploying a program stored in the storage 236 to the RAM 235 and executing the program. Also, processing described by the flowcharts is started when, for example, the discharge destination selection button 804 of FIG. 8 has been pressed. Furthermore, as processing steps S2001 to S2006 of the flowchart of FIG. 20A are the same processing as step S1101 to step S1106 of FIG. 11, a description thereof is omitted.

In a case where sheets used in a job are long and the selected tray is a tray to which a long tray has not been attached, the processing proceeds to step S2007, and the CPU 234 determines whether a setting has been configured to display a warning indicating that the selected tray is not a long tray. The determination about this setting of whether to display a warning is made based on whether the checkbox 1905 of FIG. 19 has been checked. Here, in a case where the setting for displaying a warning has been configured by checking the checkbox 1905, the processing proceeds to step S2008, and the CPU 234 adds information of this tray as an unrecommended tray to the discharge destination list information, and the processing proceeds to step S2009.

On the other hand, in a case where it has been determined that a warning is not to be displayed in step S2007, the processing proceeds to step S2006, and the CPU 234 adds information of this tray as a recommended tray to the discharge destination list as a warning need not be displayed, and the processing proceeds to step S2009. In step S2009, the CPU 234 sets the next tray as a confirmation target tray, and repeats processing of step S2003 to step S2009 until it is determined that all discharge trays have been confirmed in step S2010. Then, when it has been determined that the confirmation has finished with respect to all trays in step S2010, the processing proceeds to step S2011. In step S2011, the CPU 234 reads out the setting of the priority tray that has been described with reference to FIG. 19 from the storage 236, and the processing proceeds to step S2012.

When “no priority tray” indicating that a priority tray is not to be selected has been selected using the radio buttons 1906 in step S2012, the processing proceeds to step S2017. On the other hand, when an option other than “no priority tray” has been selected in step S2012, the processing proceeds to step S2013. In step S2013, in accordance with the type selected using the radio buttons 1906, the CPU 234 saves the designated tray at the top of the discharge destination list, and uses it as the priority tray. That is to say, here, when the “bottommost tray” has been selected, the processing proceeds to step S2014, the bottommost tray is saved at the top of the discharge destination list, and the processing proceeds to step S2017. Also, when “designate a tray” has been selected, the processing proceeds to step S2015, a tray designated by the user is saved at the top of the discharge destination list, and the processing proceeds to step S2017. Furthermore, when the “topmost tray” has been selected, the processing proceeds to step S2016, the topmost tray is saved at the top of the discharge destination list, and the processing proceeds to step S2017.

FIG. 22C is a diagram showing an example of discharge destination list information for a case where, for example, a warning indicating that the selected tray is not a long tray is not to be displayed.

In the example of FIG. 22C, all discharge trays are recommended trays, and the user designates, for example, the lower-level tray 342 of the finisher 116, which is at the top of the discharge destination list, as a discharge destination tray to which long paper is discharged.

Also, as step S2017 and step S2018 of FIG. 12 are the same as step S1111 and step S1112 of FIG. 11, a description thereof is omitted.

This processing makes it possible to select whether to display a warning screen when a tray to which a long tray has not been attached has been selected as a discharge destination at the time of selection of a discharge tray of long sheets. Also, a discharge tray desired by the user can be preferentially set as a discharge destination so as to reduce curves on routes of sheets, or to prevent a difficulty in taking out small-sized sheets.

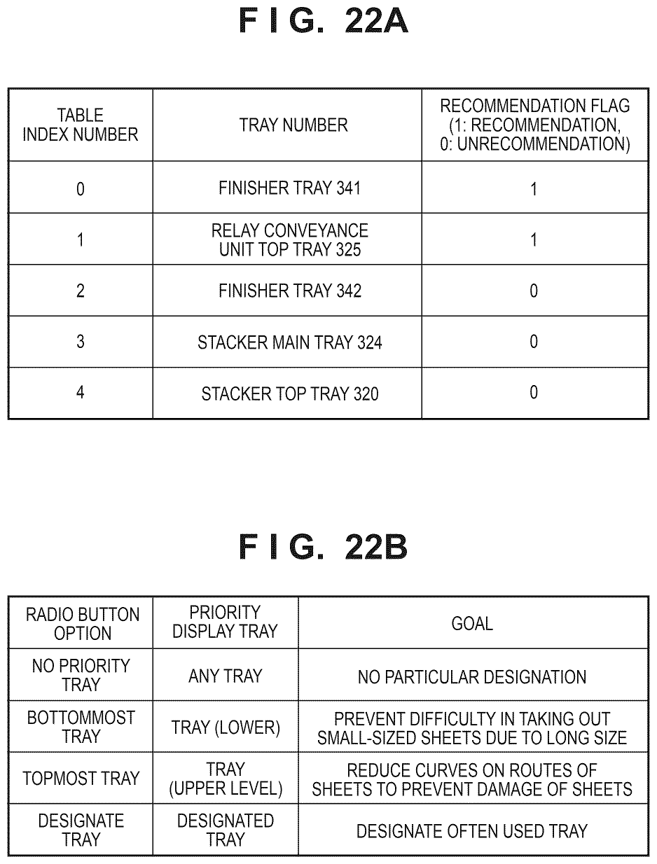

FIG. 21 depicts a view showing an example of an operation screen 2101 displayed on the display unit 232 of the information processing apparatus 109 according to the third embodiment.

This operation screen is based on the discharge destination list information of FIG. 22C. In a discharge destination selection candidate list 2104, the “tray (lower)”, which has been designated by the user to be preferentially displayed, is displayed at the top 2102 of the list. Also, as display of a warning has been disabled, trays to which the long tray 326 has not been attached are not displayed using a gray font color, unlike FIG. 8. Therefore, the warning shown in FIG. 18 is not displayed even if a discharge destination of long sheets is changed to any discharge destination.

As described above, according to the third embodiment, it is possible to select whether to display a warning screen when a tray to which a long tray has not been attached has been selected as a discharge destination at the time of selection of a discharge tray of long sheets. Also, it is possible to prevent impairment of convenience caused by repetitive display of a warning screen in a case where a specific discharge destination is repeatedly selected as a discharge tray of long sheets and this specific discharge destination is a tray to which a long tray has not been attached.

Furthermore, when selecting a discharge destination of long printed materials, it is possible to preferentially display the specific discharge destination. In this way, when selecting a discharge destination tray of long printed materials, the trouble of searching for the discharge destination tray can be reduced, and convenience can be increased.

Note that a discharge tray to which a long tray has been attached may be settable or designatable from, for example, the information processing apparatus 109. Also, alternatively, discharge trays may be provided with a sensor that detects whether they have a long tray, and a discharge tray to which a long tray has been attached may be differentiated by automatically detecting the discharge tray to which the long tray has been attached in accordance with a result of detection of this sensor.

Furthermore, in the above-described embodiments, whether a tray is suitable for long sheets is determined based on whether the long tray 326 has been attached to this tray. However, the present disclosure is not limited to this, and the determination may be made based on, for example, whether the tray originally allows discharged long sheets to be stacked thereon. Also, alternatively, the determination may be made based on whether the tray has been transformed to be compatible with long sheets as a result of the user changing its form in accordance with a size of sheets to be discharged and stacked. In other words, the determination about whether a tray is suitable for long sheets is not limited to the above-described embodiments.

### OTHER EMBODIMENTS

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims priority to Japanese Patent Application No. 2024-196047, which was filed on Nov. 8, 2024, and which is hereby incorporated by reference herein in its entirety.

What is claimed is:

1. An image forming system including an image forming apparatus that discharges a recording medium on which an image has been formed, the image forming system comprising
one or more controllers including one or more processors and one or more memories, the one or more controllers configured to:
select, from among a plurality of stacking units that are operable to stack a recording medium discharged from the image forming apparatus thereon, a stacking unit on which a recording medium discharged from the image forming apparatus as a result of execution of a job is to be stacked;
in a case where a recording medium generated in the job is a long recording medium that has a larger length than a standard-sized recording medium in a conveyance direction, determine whether the selected stacking unit is a stacking unit suitable for stacking the long recording medium; and
issue a warning if it has been determined that the selected stacking unit is not a stacking unit suitable for stacking the long recording medium.

2. The image forming system according to claim 1, wherein in the determination, the one or more controllers are configured to determine whether the selected stacking unit is suitable based on whether the selected stacking unit is a stacking unit to which a long tray has been attached, the long tray allowing the long recording medium to be stacked thereon without an occurrence of a stacking error of the long recording medium.

3. The image forming system according to claim 1, wherein in the selection, the one or more controllers are configured to display a list of the plurality of stacking units, and cause a user to select, from the list, a stacking unit on which a recording medium discharged from the image forming apparatus is to be stacked.

4. The image forming system according to claim 3, wherein in displaying the list of the plurality of stacking units, a stacking unit suitable for stacking the long recording medium is identifiably displayed.

5. The image forming system according to claim 3, wherein in displaying the list of the plurality of stacking units, a stacking unit suitable for stacking the long recording medium is preferentially displayed.

6. The image forming system according to claim 3, wherein the one or more controllers are further configured to designate a stacking unit that is preferentially displayed when the list of the plurality of stacking units is displayed.

7. The image forming system according to claim 3, wherein in displaying the list of the plurality of stacking units, a stacking unit suitable for stacking the long recording medium is displayed at a top of the list.

8. The image forming system according to claim 3, wherein in displaying the list of the plurality of stacking units, a stacking unit to which a long tray has been attached is identifiably displayed, the long tray allowing the long recording medium to be stacked thereon without an occurrence of a stacking error.

9. The image forming system according to claim 1, wherein in issuing the warning, the one or more controllers are further configured to present a solution for solving a cause of the warning.

10. The image forming system according to claim 1, wherein at the time of the issuance of the warning, the one or more controllers are further configured to decide the selected stacking unit as a stacking unit on which a recording medium discharged from the image forming apparatus is to be stacked.

11. The image forming system according to claim 1, wherein the one or more controllers are further configured to:
inspect the recording medium discharged from the image forming apparatus, and
designate a discharge destination of a recording medium that has failed the inspection, and
wherein in a case where a recording medium formed in the job is a long recording medium, the one or more controllers are configured to:
determine whether a designated stacking unit is a stacking unit suitable for stacking the long recording medium, and
issue a warning if it has been determined that the designated stacking unit is not a stacking unit suitable for stacking the long recording medium.

12. An information processing apparatus, comprising
one or more controllers including one or more processors and one or more memories, the one or more controllers configured to:
select a stacking unit on which a recording medium discharged from an image forming apparatus in which a job is to be executed is to be stacked, from among a plurality of stacking units that are operable to stack a recording medium discharged from the image forming apparatus after an image has been formed thereon;
in a case where a recording medium generated in the job is a long recording medium that has a larger length than a standard-sized recording medium in a conveyance direction, determine whether the selected stacking unit is a stacking unit suitable for stacking the long recording medium; and
issue a warning if it has been determined that the selected stacking unit is not a stacking unit suitable for stacking the long recording medium.

13. The information processing apparatus according to claim 12, wherein in the determination, the one or more controllers are configured to determine whether the selected stacking unit is suitable for stacking the long recording medium based on whether the selected stacking unit is a stacking unit to which a long tray has been attached, the long tray allowing the long recording medium to be stacked thereon without an occurrence of a stacking error.

14. The information processing apparatus according to claim 12, wherein in the selection, the one or more controllers are configured to display a list of the plurality of stacking units on a display unit, and cause a user to select, from the list, a stacking unit on which the long recording medium discharged from the image forming apparatus is to be stacked.

15. The information processing apparatus according to claim 14, wherein in displaying the list of the plurality of stacking units, a stacking unit suitable for stacking the long recording medium is identifiably displayed.

16. The information processing apparatus according to claim 14, wherein in displaying the list of the plurality of stacking units, a stacking unit suitable for stacking the long recording medium is preferentially displayed.

17. The information processing apparatus according to claim 14, wherein the one or more controllers are further configured to designate a stacking unit that is preferentially displayed when the list of the plurality of stacking units is displayed.

18. The information processing apparatus according to claim 14, wherein in displaying the list of the plurality of stacking units, a stacking unit suitable for stacking the long recording medium is displayed at a top of the list.

19. The information processing apparatus according to claim 14, wherein in displaying the list of the plurality of stacking units, a stacking unit to which a long tray has been attached is identifiably displayed, the long tray allowing the long recording medium to be stacked thereon without an occurrence of a stacking error.

20. The information processing apparatus according to claim 12, wherein in issuing the warning, the one or more controllers are further configured to present a solution for solving a cause of the warning.

21. The information processing apparatus according to claim 12, wherein in issuing the warning, the one or more controllers are further configured to decide the selected stacking unit as a stacking unit on which a recording medium discharged from the image forming apparatus is to be stacked.

22. The information processing apparatus according to claim 12, wherein in a case where an inspection apparatus that inspects the recording medium discharged from the image forming apparatus is connected to the image forming apparatus, the one or more controllers are further configured to designate a discharge destination of a recording medium that has failed the inspection by the inspection apparatus, and
wherein in a case where a recording medium formed in the job is a long recording medium, the one or more controllers are further configured to:
determine whether a designated stacking unit is a stacking unit suitable for stacking the long recording medium, and
issue a warning if it has been determined that the designated stacking unit is not a stacking unit suitable for stacking the long recording medium.
